(19) United States
(12) Patent Application Publication
(10) Pub. No.: US 2023/0048114 A1
(43) Pub. Date: Feb. 16, 2023

(54) METHOD AND DEVICE IN NODES USED FOR WIRELESS COMMUNICATION

(71) Applicants: Keying WU, SHANGHAI (CN); Xiaobo ZHANG, SHANGHAI (CN)

(72) Inventors: Keying WU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/973,491

(22) Filed: Oct. 25, 2022

Related U.S. Application Data
(63) Continuation of application No. PCT/CN2022/080782, filed on Mar. 14, 2022.

(30) Foreign Application Priority Data
Mar. 19, 2021 (CN) 202110305103.9

(51) Int. Cl. H04L 5/00; H04W 72/04

(52) U.S. Cl. CPC H04L 5/0051; H04L 5/0053; H04W 72/042; H04L 5/0078

(57) ABSTRACT

The present disclosure provides a method and device in a node for wireless communications. A first node determines a first resource set and a first resource set group out of M resource sets; monitors a first-type channel in the first resource set group in a first time window. Any two of the M resource sets are overlapped in time domain, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group. The above method avoids the performance loss incurred by UE's unnecessary dropping the monitoring on some PDCCH candidates.

### CROSS REFERENCE TO RELATED APPLICATIONS

This application is the continuation of the International patent application No. PCT/CN2022/080782, filed on Mar. 14, 2022, which claims the priority benefit of Chinese Patent Application No. 202110305103.9, filed on Mar. 19, 2021, the full disclosure of which is incorporated herein by reference.

### BACKGROUND

### Technical Field

The present disclosure relates to transmission methods and devices in wireless communication systems, and in particular to a method and device of radio signal transmission in a wireless communication system supporting cellular networks.

### Related Art

Multi-antenna technology is a key technique in both 3rd Generation Partner Project (3GPP) Long-term Evolution (LTE) system and New Radio (NR) system. By configuring multiple antennas at a communication node, for instance, at a base station or a User Equipment (UE) to acquire extra spatial degrees of freedom. The multiple antennas form through beamforming a beam pointing in a specific direction to improve communication quality. When the multiple antennas belong to multiple Transmitter Receiver Points (TRPs)/panels, the spatial differences among these TRPs/panels can be utilized to get extra diversity/multiplexing gains. In NR release (R) R16, multi-TRP based repetition is used to improve transmission reliability of downlink physical layer data channel.

### SUMMARY

In NR 17 and its subsequent version, transmission schemes based on multi-TRP/panel will continue to be evolved, one important aspect of which is to enhance physical layer control channel. At 3GPP Radio Access Network (RAN) 1#103-e meeting, the scheme of allocating two activated Transmission Configuration Indicator (TCI) states to a same COntrol REsource SET (CORESET) and the scheme of merging and decoding between two Physical Downlink Control Channel (PDCCH) candidates associated with different CORESETs are passed. In NR R16, for overlapped PDCCH candidates in time domain, a UE only needs to monitor a PDCCH candidate with a same Quasi Co-Location (QCL)-typeD characteristic as a specific CORESET. When a PDCCH candidate is related to two TCI states, the impact on the monitoring of overlapped PDCCH candidates in time domain is a problem to be solved.

To address the above problem, the present disclosure provides a solution. It should be noted that although the above description adopts the transmission scenarios of multi-TRP/panel transmission and control channel as an example, the application is also applicable to other scenarios, such as single TRP/panel transmission, other physical layer channels, carrier aggregation or Internet of things (V2X), where similar technical effects can be achieved. Additionally, the adoption of a unified solution for various scenarios (including but not limited to multi-TRP/panel transmission, signal-TRP/panel transmission, control channel, other physical layer channels, Carrier Aggregation and V2X) contributes to the reduction of hardware complexity and costs. If no conflict is incurred, embodiments in a first node in the present disclosure and the characteristics of the embodiments are also applicable to a second node, and vice versa. And the embodiments in the present disclosure and the characteristics in the embodiments can be arbitrarily combined if there is no conflict.

The present disclosure provides a method in a first node for wireless communications, comprising:

determining a first resource set and a first resource set group out of M resource sets, M being a positive integer greater than 1; and

monitoring a first-type channel in the first resource set group in a first time window;

herein, any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, a problem to be solved in the present disclosure includes: when there exists one of overlapped PDCCH candidates in time domain being related to two TCI states, how to determine the PDCCH candidate to be monitored. The above method determines a PDCCH candidate for monitoring according to whether the first resource set is connected to one or two spatial states, so as to solve the problem.

In one embodiment, characteristics of the above method include: the M resource sets comprise overlapped PDCCH candidates in time domain, where a PDCCH candidate comprised in the first resource set needs to be monitored; how to determine which other PDCCH candidates in the overlapped PDCCH candidates need to be monitored is related to whether the first resource set is connected to one or two spatial states.

In one embodiment, advantages of the above method include: PDCCH candidates that can be monitored at the same time are determined according to the capability of a UE, which avoids the performance loss incurred by unnecessary dropping monitoring on some PDCCH candidates.

In one embodiment, advantages of the above method include: when PDCCH candidates are overlapped in time domain, the freedom degree of the scheduling of the base station is improved.

According to one aspect of the present disclosure, wherein a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

According to one aspect of the present disclosure, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state.

According to one aspect of the present disclosure, wherein the second condition set comprises a second condition, the second condition comprises that the first node is configured with a first higher-layer parameter and a value of the first higher-layer parameter belongs to a first parameter value set, and the first parameter value set comprises at least one parameter value.

According to one aspect of the present disclosure, wherein the first node is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

According to one aspect of the present disclosure, comprising:

receiving first information;

herein, the first information is used to determine the first condition.

According to one aspect of the present disclosure, wherein when the reference resource set is connected to a third spatial state and a fourth spatial state, the reference spatial state is a default one of the third spatial state and the fourth spatial state, or the reference spatial state is any of the third spatial state and the fourth spatial state.

According to one aspect of the present disclosure, wherein the first node is a UE.

According to one aspect of the present disclosure, wherein the first node is a relay node.

The present disclosure provides a method in a second node for wireless communications, comprising:

transmitting or dropping transmitting a first-type channel in a first resource set group in a first time window;

herein, the first resource set group comprises at least one resource set in M resource sets, M being a positive integer greater than 1; any two of the M resource sets are overlapped in time domain in the first time window; a target receiver of the first-type channel determines a first resource set and the first resource set group out of the M resource sets, and monitors the first-type channel in the first resource set group; the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

According to one aspect of the present disclosure, wherein a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

According to one aspect of the present disclosure, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state.

According to one aspect of the present disclosure, wherein the second condition set comprises a second condition, the second condition comprises that the target receiver of the first-type channel is configured with a first higher-layer parameter and a value of the first higher-layer parameter belongs to a first parameter value set, and the first parameter value set comprises at least one parameter value.

According to one aspect of the present disclosure, wherein the target receiver of the first-type channel is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

According to one aspect of the present disclosure, comprising:

transmitting first information;

herein, the first information is used to determine the first condition.

According to one aspect of the present disclosure, wherein when the reference resource set is connected to a third spatial state and a fourth spatial state, the reference spatial state is a default one of the third spatial state and the fourth spatial state, or the reference spatial state is any of the third spatial state and the fourth spatial state.

According to one aspect of the present disclosure, wherein the second node is a base station.

According to one aspect of the present disclosure, wherein the second node is a UE.

According to one aspect of the present disclosure, wherein the second node is a relay node.

The present disclosure provides a first node for wireless communications, comprising:

a first processor, determining a first resource set and a first resource set group out of M resource sets, and monitoring a first-type channel in the first resource set group in a first time window, M being a positive integer greater than 1;

herein, any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

The present disclosure provides a second node for wireless communications, comprising:

a second processor, transmitting or dropping transmitting a first-type channel in a first resource set group in a first time window;

herein, the first resource set group comprises at least one resource set in M resource sets, M being a positive integer greater than 1; any two of the M resource sets are overlapped in time domain in the first time window; a target receiver of the first-type channel determines a first resource set and the first resource set group out of the M resource sets, and monitors the first-type channel in the first resource set group; the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, the present disclosure has the following advantages over conventional schemes:

PDCCH candidates that can be monitored at the same time are determined according to the capability of a UE, which avoid the performance loss incurred by unnecessary dropping monitoring on some PDCCH candidates;

when PDCCH candidates are overlapped in time domain, the freedom degree of the scheduling of the base station is improved.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of M resource sets, a first resource set, a first resource set group and a first-type channel according to one embodiment of the present disclosure;

FIG. 2 illustrates a schematic diagram of a network architecture according to one embodiment of the present disclosure;

FIG. 3 illustrates a schematic diagram of a radio protocol architecture of a user plane and a control plane according to one embodiment of the present disclosure;

FIG. 4 illustrates a schematic diagram of a first communication device and a second communication device according to one embodiment of the present disclosure;

FIG. 5 illustrates a flowchart of wireless communications according to one embodiment of the present disclosure;

FIG. 6 illustrates a schematic diagram of a first node monitoring a first-type channel in a first resource set group in a first time window according to one embodiment of the present disclosure;

FIG. 7 illustrates a schematic diagram of a spatial state to which a given resource set being connected according to one embodiment of the present disclosure;

FIG. 8 illustrates a schematic diagram of whether a second condition set is satisfied being used to determine a first condition according to one embodiment of the present disclosure;

FIG. 9 illustrates a schematic diagram of a second condition according to one embodiment of the present disclosure;

FIG. 10 illustrates a schematic diagram of a third condition according to one embodiment of the present disclosure;

FIG. 11 illustrates a schematic diagram of first information being used to determine a first condition according to one embodiment of the present disclosure;

FIG. 12 illustrates when a reference resource set is linked to a third spatial state and a fourth spatial state, a schematic diagram of a reference spatial state according to one embodiment of the present disclosure;

FIG. 13 illustrates a structure block diagram of a processing device in a first node according to one embodiment of the present disclosure;

FIG. 14 illustrates a structure block diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

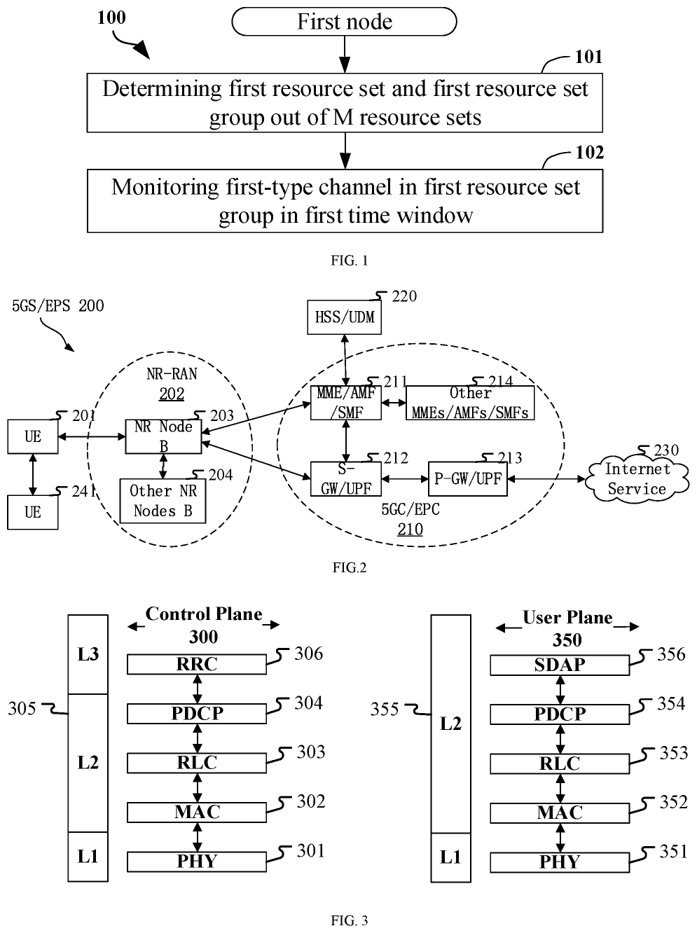

Embodiment 1 illustrates a flowchart of M resource sets, a first resource set, a first resource set group and a first-type channel according to one embodiment of the present disclosure, as shown in FIG. 1. In 100 illustrated by FIG. 1, each box represents a step. Particularly, the sequential order of steps in these boxes does not necessarily mean that the steps are chronologically arranged.

In embodiment 1, the first node in the present disclosure determines a first resource set and a first resource set group out of M resource sets in step 101; monitors a first-type channel in the first resource set group in a first time window in step 102; herein, M is a positive integer greater than 1; any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, if the first resource set is connected to only the first spatial state, the first condition comprises that the first spatial state and the reference spatial state are configured with same properties for the first QCL type; if the first resource set is connected to the first spatial state and the second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, when the first resource set is connected to the first spatial state and the second spatial state, the first condition comprises that a default one of the first spatial state and the second spatial state is configured with same properties for the first QCL type as the reference spatial state.

In one embodiment, when the first resource set is connected to the first spatial state and the second spatial state, the first condition comprises that there exists one of the first spatial state and the second spatial state being configured with same properties for the first QCL type as the reference spatial state.

In one embodiment, if the first condition comprises that a default one of the first spatial state and the second spatial state being configured with same properties for the first QCL type as the reference spatial state, and when the other one of the first spatial state and the second spatial state different from the default spatial state is configured with same properties for the first QCL type as the reference spatial state but the default spatial state and the reference spatial state are configured with different characteristics for the first QCL type, the first condition is not satisfied.

In one embodiment, if the first condition comprises that there exits one of the first spatial state and the second spatial state being configured with same properties for the first QCL type as the reference spatial state, no matter which of the first spatial state and the second spatial state is configured with same properties for the first QCL type as the reference spatial state, the first condition is satisfied.

In one embodiment, when the first resource set is connected to the first spatial state and the second spatial state, the first condition only comprises that a default one of the first spatial state and the second spatial state is configured with same properties for the first QCL type as the reference spatial state, or, the first condition only comprises that there exists one of the first spatial state and the second spatial state being configured with same properties for the first QCL type as the reference spatial state.

In one embodiment, the meaning of the phrase of a resource set being connected to two spatial states includes: the resource set is connected to two spatial states at the same time.

In one embodiment, the meaning of the phrase of a resource set being connected to one spatial states includes: the resource set is connected to only one spatial state.

In one embodiment, M is not greater than 5.

In one embodiment, M is not greater than 3.

In one embodiment, M is not greater than 8.

In one embodiment, the M resource sets respectively comprise M CORESETs.

In one embodiment, the M resource sets are respectively M CORESETs.

In one embodiment, the M resource sets respectively comprise M search space sets.

In one embodiment, any of the M resource sets comprises at least one PDCCH candidate.

In one embodiment, the M resource sets respectively comprise PDCCH candidates of M CORESETs located within the first time window.

In one embodiment, the M resource sets respectively consist of PDCCH candidates of M CORESETs located within the first time window.

In one embodiment, any of the M resource sets comprises time-frequency resources.

In one embodiment, any of the M resource sets comprises at least one Resource Element (RE) in time-frequency domain.

In one embodiment, an RE occupies a symbol in time domain and a subcarrier in frequency domain.

In one embodiment, the symbol is an Orthogonal Frequency Division Multiplexing (OFDM) symbol.

In one embodiment, the symbol is a Single Carrier-Frequency Division Multiple Access (SC-FDMA) symbol.

In one embodiment, the symbol is a Discrete Fourier Transform Spread OFDM (DFT-S-OFDM) symbol.

In one embodiment, any of the M resource sets occupies at least one subcarrier in frequency domain.

In one embodiment, any of the M resource sets occupies at least one Physical Resource Block (PRB) in frequency domain.

In one embodiment, any of the M resource sets occupies at least one symbol in time domain.

In one embodiment, any of the M resource sets occupies at least one slot in time domain.

In one embodiment, there exists one of the M resource sets occurring only once in time domain.

In one embodiment, there exists one of the M resource sets occurring a plurality of times in time domain.

In one embodiment, any of the M resource sets occurs a plurality of times in time domain.

In one embodiment, there exists one of the M resource sets occurring periodically in time domain.

In one embodiment, there exists one of the M resource sets occurring aperiodically in time domain.

In one embodiment, the M resource sets belong to a same carrier.

In one embodiment, the M resource sets belong to a same BandWidth Part (BWP).

In one embodiment, the M resource sets belong to a same cell.

In one embodiment, there exist two of the M resource sets belonging to different carriers.

In one embodiment, there exist two of the M resource sets belonging to different BWPs.

In one embodiment, there exist two of the M resource sets belonging to different cells.

In one embodiment, the M resource sets are respectively identified by M resource set indexes, and the M resource set indexes are respectively M non-negative integers.

In one subembodiment of the above embodiment, the M resource set indexes are not equal to each other.

In one subembodiment of the above embodiment, the M resource sets are divided into M1 group(s), M1 being a positive integer not greater than M; any of the M1 group(s) comprises at least one resource set in the M resource sets, and all resource sets comprised in any of the M1 group(s) belong to a same cell; for any given group in the M1 group(s), if a number of resource sets comprised in the given group is greater than 1, resource set indexes corresponding to any two resource sets comprised in the given group are not equal.

In one embodiment, the M resource set indexes respectively comprise M ControlResourceSetIds.

In one embodiment, the M resource set indexes are receptively M ControlResourceSetIds.

In one embodiment, the M resource set indexes respectively comprise M SearchSpaceIds.

In one embodiment, the first resource set group comprises at least one resource set.

In one embodiment, the first resource set group comprises at least one resource set in the M resource sets.

In one embodiment, the first resource set group comprises at least one resource set other than the first resource set.

In one embodiment, the first resource set group only comprises the first resource set.

In one embodiment, any resource set in the first resource set group belongs to the M resource sets.

In one embodiment, the first resource set group comprises all resource sets in the M resource sets.

In one embodiment, there exists one of the M resource sets not belonging to the first resource set group.

In one embodiment, an index of a cell to which the M resource sets belongs is used to determine the first resource set out of the M resource sets.

In one embodiment, an index of a search space set associated with one of the M resource sets is used to determine the first resource set out of the M resource sets.

In one embodiment, an index of a search space set of a cell to which the M resource sets belongs is used to determine the first resource set out of the M resource sets.

In one embodiment, resource set indexes corresponding to the M resource sets are used to determine the first resource set out of the M resource sets.

In one embodiment, CORESETpoolIndexes corresponding to the M resource sets are used to determine the first resource set out of the M resource sets.

In one embodiment, whether there is a Common Search Space (CSS) set being associated with one of the M resource sets is used to determine the first resource set out of the M resource sets.

In one embodiment, if there exists a CSS set being associated with one of the M resource sets, the first resource set is one of the M resource sets to which a first CSS set is associated; the first CSS set is a CSS set with a lowest search space set index of a cell with a lowest cell index among cells comprising CSS sets.

In one subembodiment of the above embodiment, the first CSS set is a CSS set with a lowest search space set index of a cell with a lowest cell index comprising CSS sets among cells to which the M resource sets respectively belong.

In one embodiment, if for any of the M resource sets, there does not exist a CSS set being associated with the any resource set, and the first resource set is one of the M resource sets to which a first UE-specific Search Space (USS) set is associated; the first USS set is a USS set with a lowest search space set index among USS sets in which at least one PDCCH candidate is located within the first time window in time domain of a cell with a lowest cell index.

In one subembodiment of the above embodiment, the first USS set is a USS set with a lowest search space set index among USS sets in which at least one PDCCH candidate is located within the first time window in time domain of a cell with a lowest cell index among cells to which the M resource sets respectively belong.

In one embodiment, the first resource set is one of the M resource sets corresponding to a lowest resource set index.

In one embodiment, the first resource set is one of the M resource sets corresponding to a lowest resource set index belonging to resource sets of a first cell; the first cell is a cell corresponding to a lowest cell index among cells to which the M resource sets belong.

In one embodiment, the first time window is a consecutive duration.

In one embodiment, the first time window comprises at least one consecutive symbol.

In one embodiment, the first time window comprises at least one PDCCH monitoring occasion.

In one embodiment, the first time window comprises M PDCCH monitoring occasions, the M PDCCH monitoring occasions respectively belong to the M resource sets, and any two of the M PDCCH monitoring occasions are overlapped in time domain.

In one subembodiment of the above embodiment, the first time window consists of the M PDCCH monitoring occasions.

In one embodiment, the meaning of the phrase of any two of the M resource sets being overlapped in time domain in the first time window includes: any two of the M resource sets comprise PDCCH monitoring occasions being located within the first time window and overlapped in time domain.

In one embodiment, the meaning of the phrase of any two of the M resource sets being overlapped in time domain in the first time window includes: any two of the M resource sets comprise PDCCH candidates being located within the first time window and overlapped in time domain.

In one embodiment, the meaning of the phrase of any two of the M resource sets being overlapped in time domain in the first time window includes: for any two of the M resource sets, the two resource sets respectively comprise a first PDCCH candidate and a second PDCCH candidate, a PDCCH monitoring occasion to which the first PDCCH candidate belongs and a PDCCH monitoring occasion to which the second PDCCH candidate belongs both belong to the first time window in time domain and are overlapped in time domain.

In one embodiment, the meaning of the phrase of “monitoring a first-type channel in the first resource set group in a first time window” includes: monitoring the first-type channel in PDCCH candidates located within the first time window of each resource set comprised in the first resource set group in the first time window.

In one embodiment, the meaning of the phrase of “monitoring a first-type channel in the first resource set group in a first time window” includes: monitoring the first-type channel in a PDCCH monitoring occasion located within the first time window of each resource set comprised in the first resource set group in the first time window.

In one embodiment, the spatial state comprises a TCI state.

In one embodiment, the spatial state is a TCI state.

In one embodiment, the spatial state comprises a QCL relationship.

In one embodiment, the spatial state is a QCL relationship.

In one embodiment, the spatial state comprises a spatial relation.

In one embodiment, the spatial state indicates one or two reference signals, the one or two reference signals comprise at least one of a Channel State Information-Reference Signal (CSI-RS), a Synchronization Signal/physical broadcast channel Block (SSB) or a Sounding Reference Signal (SRS).

In one embodiment, the spatial state indicates QCL relationships among a DeModulation Reference Signals (DMRS) port of a Physical Downlink Shared CHannel (PDSCH), a DMRS port or a CSI-RS port of a PDCCH and one or two reference signals.

In one embodiment, the first spatial state and the second spatial state respectively correspond to different TCI-StateIds.

In one embodiment, the first spatial state indicates a third reference signal, the second spatial state indicates a fourth reference signal, and the third reference signal and the fourth reference signal are not quasi co-located.

In one subembodiment of the above embodiment, the first spatial state indicates that a QCL type corresponding to the third reference signal is the first QCL type, and the second spatial state indicates that a QCL type corresponding to the fourth reference signal is the first QCL type.

In one subembodiment of the above embodiment, the third reference signal and the fourth reference signal are not quasi co-located corresponding to the first QCL type.

In one embodiment, the first QCL type is one of QCL-TypeA, QCL-TypeB, QCL-TypeC or QCL-TypeD.

In one embodiment, the first QCL type is QCL-TypeD.

In one embodiment, the reference resource block is only connected to the reference spatial state.

In one embodiment, the reference resource block is also connected to another spatial state other than the reference spatial state.

In one embodiment, if the reference resource set satisfies the first condition, the reference resource set belongs to the first resource set group.

In one embodiment, if the reference resource set does not satisfy the first condition, the reference resource set does not belong to the first resource set group.

In one embodiment, when and only when the reference resource set satisfies the first condition, the reference resource set belongs to the first resource set group.

In one embodiment, when and only when the reference resource set does not satisfy the first condition, the reference resource set does not belong to the first resource set group.

In one embodiment, when the first resource set is connected to only the first spatial state, the number of spatial state(s) to which the first resource set is connected is equal to 1; and when the first resource set is connected to the first spatial state and the second spatial state, the number of spatial state(s) to which the first resource set is connected is equal to 2.

In one embodiment, the meaning of the phrase of a spatial state and another spatial state being configured with same properties for the first QCL type includes: the spatial state indicates a first reference signal and indicates that a QCL type corresponding to the first reference signal is the first QCL type, and the another spatial state indicates a second reference signal and indicates that a QCL type corresponding to the second reference signal is the first QCL type; the first reference signal is the second reference signal, or, the first reference signal and the second reference signal are quasi co-located.

In one subembodiment of the above embodiment, the spatial state is the first spatial state, and the another spatial state is the reference spatial state.

In one subembodiment of the above embodiment, the spatial state is the first spatial state or the second spatial state, and the another spatial state is the reference spatial state.

In one subembodiment of the above embodiment, the spatial state is the first spatial state or the second spatial state, and the another spatial state is the third spatial state or the fourth spatial state.

In one subembodiment of the above embodiment, the first reference signal and the second reference signal are quasi co-located corresponding to QCL-TypeD.

In one subembodiment of the above embodiment, the first reference signal and the second reference signal are quasi co-located and the corresponding QCL type is the first QCL type.

In one subembodiment of the above embodiment, the first reference signal comprises one of a CSI-RS, an SSB an SRS.

In one subembodiment of the above embodiment, the second reference signal comprises one of a CSI-RS, an SSB an SRS.

In one subembodiment of the above embodiment, the reference signal comprises a reference signal resource.

In one subembodiment of the above embodiment, the reference signal comprises a reference signal port.

In one subembodiment of the above embodiment, the meaning of the phrase of the first reference signal being the second reference signal includes: the first reference signal and the second reference signal correspond to a same reference signal index; the reference signal index comprises at least one a NZP-CSI-RS-ResourceId, an SSB-Index or an SRS-ResourceId.

In one embodiment, the meaning of the default includes no need to be configured.

In one embodiment, the meaning of the default includes no need to be configured by a higher layer signaling.

In one embodiment, the meaning of the default includes no need to be configured by a Radio Resource Control (RRC) signaling.

In one embodiment, the meaning of the default includes no need to be configured by an L1 signaling.

In one embodiment, the meaning of the default includes no need to be configured by a physical layer signaling.

In one embodiment, the meaning of the default includes being predefined.

In one embodiment, the meaning of the default includes being configured by a higher layer signaling.

In one embodiment, the meaning of the default includes being configured by an RRC signaling.

In one embodiment, the meaning of the default includes being determined according to predetermined rules.

In one embodiment, the default one of the first spatial state and the second spatial state is one of the first spatial state and the second spatial state corresponding to a smaller spatial state index.

In one embodiment, the default one of the first spatial state and the second spatial state is one of the first spatial state and the second spatial state corresponding to a larger spatial state index.

In one embodiment, the spatial state is a TCI state, and the spatial state index is a TCI-StateId.

In one embodiment, the default one of the first spatial state and the second spatial state is configured by a higher layer signaling.

In one embodiment, the default one of the first spatial state and the second spatial state is configured by an RRC signaling.

In one embodiment, a first information block sequentially indicates the first spatial state and the second spatial state, and the default one of the first spatial state and the second spatial default is a first one of the first spatial state and the second spatial state indicated by the first information block.

In one subembodiment of the above embodiment, the first information block comprises configuration information of the first resource set, the configuration information of the first resource set comprises one or more of a resource set index, frequency-domain resources, a duration time, a mapping type from a Control channel element (CCE) to a Resource Element Group (REG), a pre-coding granularity or a TCI state corresponding to the first resource set.

In one subembodiment of the above embodiment, the first information block comprises all or partial information in an Information Element (IE).

In one subembodiment of the above embodiment, the first information block is a ControlResourceSet IE corresponding to the first resource set.

In one subembodiment of the above embodiment, the first information block is used to activate the first spatial state and the second spatial state for the first resource set.

In one subembodiment of the above embodiment, the first information block comprises a Medium Access Control layer Control Element (MAC CE).

In one subembodiment of the above embodiment, the first information block comprises a TCI State Indication for UE-specific PDCCH MAC CE.

### Embodiment 2

Embodiment 2 illustrates a schematic diagram of a network architecture according to one embodiment of the present disclosure, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present disclosure can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present disclosure comprises the UE 201.

In one embodiment, the second node in the present disclosure comprises the gNB 203.

In one embodiment, a radio link between the UE 201 and the gNB 203 is a cellular network link.

In one embodiment, a transmitter of the first-type channel in the present disclosure comprises the gNB 203.

In one embodiment, a receiver of the first-type channel in the present disclosure comprises the UE 201.

### Embodiment 3

Embodiment 3 illustrates a schematic diagram of a radio protocol architecture of a user plane and a control plane according to one embodiment of the present disclosure, as shown in FIG. 3.

Embodiment 3 illustrates a schematic diagram of an example of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first-type channel is generated by the PHY 301 or the PHY 351.

In one embodiment, the first information is generated by the PHY 301 or the PHY 351.

In one embodiment, the first information is generated by the MAC sublayer 302 or the MAC sublayer 352.

In one embodiment, the first information is generated by the RRC sublayer 306.

### Embodiment 4

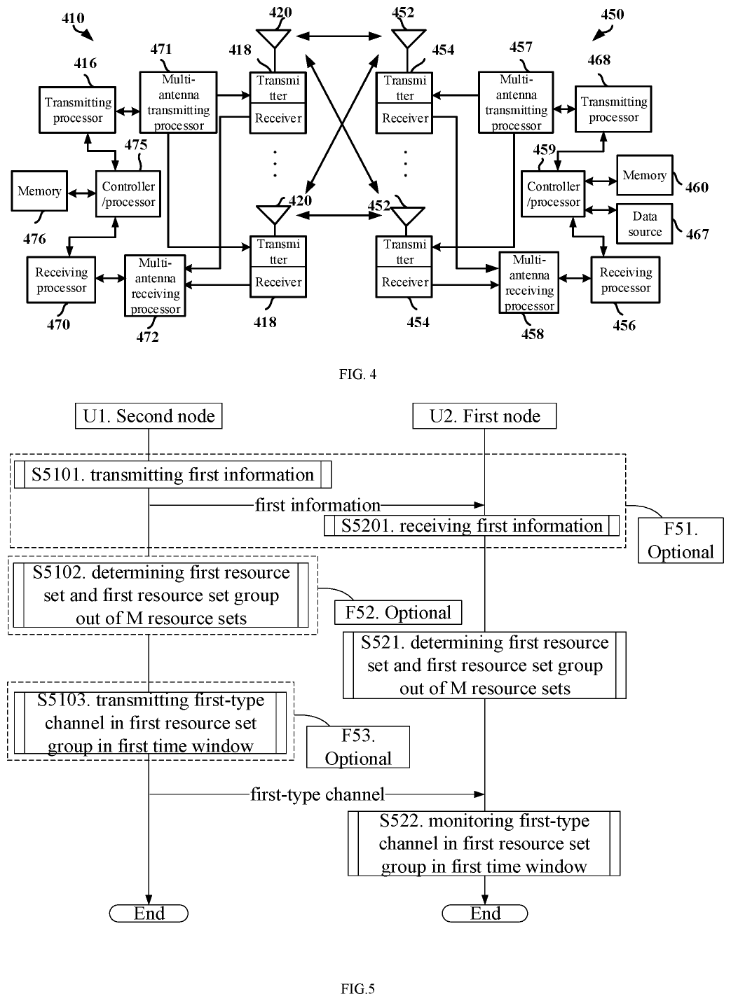

Embodiment 4 illustrates a schematic diagram of a first communication device and a second communication device according to one embodiment of the present disclosure, as shown in FIG. 4. FIG. 4 is a block diagram of a first communication device 410 in communications with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: determines the first resource set and the first resource set group out of the M resource sets; and monitors the first-type channel in the first resource set group in the first time window.

In one embodiment, the second communication device 450 comprises a memory that stores a computer readable instruction program. The computer readable instruction program generates an action when executed by at least one processor. The action includes: determining the first resource set and the first resource set group out of the M resource sets; and monitoring the first-type channel in the first resource set group in the first time window.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits or drops transmitting the first-type channel in the first resource set group in the first time window.

In one embodiment, the first communication device 410 comprises a memory that stores a computer readable instruction program. The computer readable instruction program generates an action when executed by at least one processor. The action includes: transmitting or dropping transmitting the first-type channel in the first resource set group in the first time window.

In one embodiment, the first node comprises the second communication device 450 in the present disclosure.

In one embodiment, the second node in the present disclosure comprises the first communication device 410.

In one embodiment, at least one of the receiving processor 456, the multi-antenna receiving processor 458, the controller/processor 459, the memory 460, or the data source 467 is used to determine the first resource set and the first resource set group out of the M resource sets.

In one embodiment, at least one of the antenna 452, the receiver 454, the receiving processor 456, the multi-antenna receiving processor 458, the controller/processor 459, the memory 460, or the data source 467 is used to monitor the first-type channel in the first resource set group in the first time window; at least one of the antenna 420, the receiver 418, the receiving processor 416, the multi-antenna transmitting processor 471, the controller/processor 475, or the memory 476 is used to transmit the first-type channel in the first resource set group in the first time window.

In one embodiment, at least one of the antenna 452, the receiver 454, the receiving processor 456, the multi-antenna receiving processor 458, the controller/processor 459, the memory 460, or the data source 467 is used to receive the first information in the present disclosure; at least one of the antenna 420, the transmitter 418, the transmitting processor 416, the multi-antenna transmitting processor 471, the controller/processor 475, or the memory 476 is used to transmit the first information.

### Embodiment 5

Embodiment 5 illustrates a flowchart of wireless transmission according to one embodiment in the present disclosure, as shown in FIG. 5. In FIG. 5, a second node U1 and a first node U2 are communication nodes transmitted via air interfaces. In FIG. 5, steps in F51 and F53 are respectively optional.

The second node U1 transmits first information in step S5101; determines a first resource set and a first resource set group out of M resource sets in step S5102; transmits a first-type channel in a first resource set group in a first time window in step S5103.

The first node U2 receives first information in step S5201; determines a first resource set and a first resource set group out of M resource sets in step S521; monitors a first-type channel in a first resource set group in a first time window in step S522.

In Embodiment 5, M is a positive integer greater than 1; any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used by the first node U2 to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, the first node U2 is the first node in the present disclosure.

In one embodiment, the second node U1 is the second node in the present disclosure.

In one embodiment, an air interface between the second node U1 and the first node U2 comprises a radio interface between a base station and a UE.

In one embodiment, an air interface between the second node U1 and the first node U2 comprises a radio interface between UEs.

In one embodiment, the second node U1 is a serving cell maintenance base station of the first node U2.

In one embodiment, the first node determines the first resource set out of the M resource sets according to predetermined rules.

In one embodiment, the first node determines the first resource set out of the M resource sets according to the first condition.

In one embodiment, the meaning of the phrase of “monitoring a first-type channel in the first resource set group in a first time window” includes: monitoring the first-type channel in only the first resource set group in the M resource sets in the first time window.

In one embodiment, the first node drops monitoring the first-type channel in any of the M resource sets not belonging to the first resource set group in the first time window.

In one embodiment, the above method in a first node used for wireless communications comprises:

the first node determines the first condition by itself.

In one embodiment, the first node determines the first condition by itself according to a number of spatial states to which the first resource set is connected.

In one embodiment, when and only when the first resource set is linked to two spatial states, the first node determines the first condition by itself.

In one embodiment, when the first resource set is connected to the first spatial state and the second spatial state, the first node determines by itself whether the first condition comprises that a default one of the first spatial state and the second spatial state is configured with same properties for the first QCL type as the reference state, or comprises that there exists one of the first spatial state and the second spatial state being configured with same properties for the first QCL type as the reference spatial state.

In one embodiment, steps in block F51 in FIG. 5 exist, and the first information is used by the first node to determine the first condition.

In one embodiment, the first information is transmitted on a PDSCH.

In one embodiment, the first information is transmitted on a PDCCH.

In one embodiment, steps in block F52 in FIG. 5 exist, and the above method in a second node for wireless communications comprises:

determining the first resource set and the first resource set group out of the M resource sets.

In one embodiment, the second node uses a same method as the first node to determine the first resource set out of the M resource sets.

In one embodiment, the second node uses a same method as the first node to determine the first resource set group out of the M resource sets.

In one embodiment, whether the reference resource set satisfies the first condition is used by the second node U1 to determine whether the reference resource set belongs to the first resource set group.

In one embodiment, the target receiver of the first-type channel is a target receiver of Downlink control information (DCI) transmitted in the first-type channel.

In one embodiment, the step in block F53 in FIG. 5 exists, and the second node transmits the first-type channel in the first resource set group in the first time window.

In one embodiment, the step in block F53 in FIG. 5 does not exist, and the second node drops transmitting the first-type channel in the first resource set group in the first time window.

### Embodiment 6

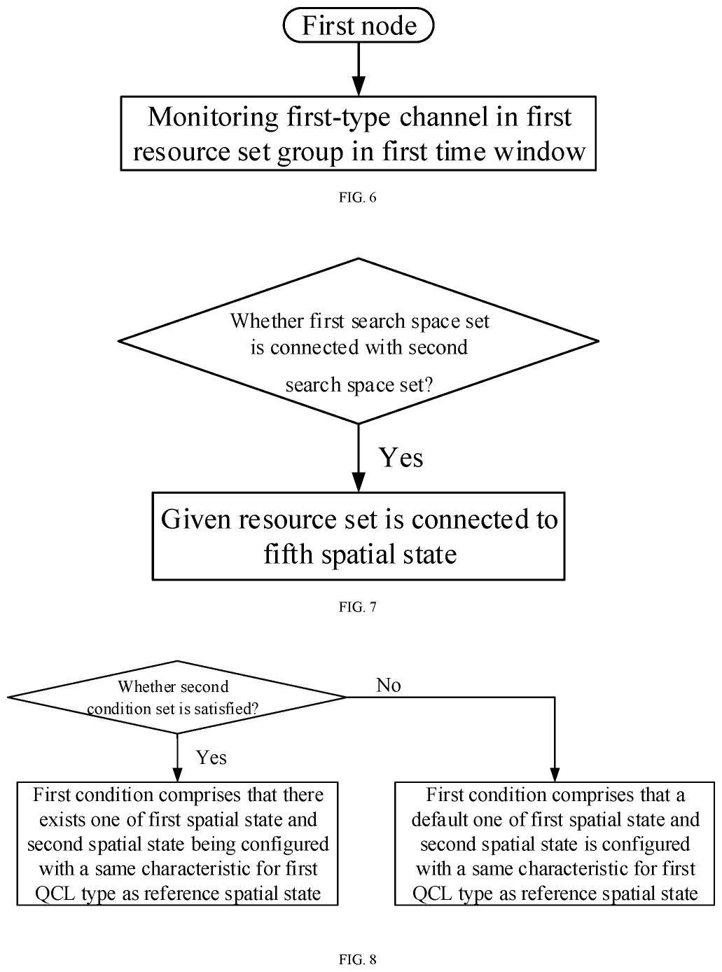

Embodiment 6 illustrates a schematic diagram of a first node monitoring a first-type channel in a first resource set group in a first time window according to one embodiment of the present disclosure, as shown in FIG. 6.

In one embodiment, the first-type channel comprises a physical channel.

In one embodiment, the first-type channel is a physical channel.

In one embodiment, the first-type channel comprises an L1 channel.

In one embodiment, the first-type channel is an L1 channel.

In one embodiment, the first-type channel comprises a downlink physical layer control channel (i.e., a downlink channel only capable of carrying a physical layer signaling).

In one embodiment, the first-type channel comprises a PDCCH.

In one embodiment, the first-type channel is a PDCCH.

In one embodiment, the first-type channel carries DCI.

In one embodiment, the meaning of the phrase of monitoring a first-type channel includes: monitoring a DCI format transmitted in the first-type channel.

In one embodiment, the meaning of the phrase of monitoring a first-type channel includes: monitoring a PDCCH candidate to judge whether the first-type channel is transmitted.

In one embodiment, the meaning of the phrase of monitoring a first-type channel includes: monitoring a PDCCH candidate to judge whether the first-type channel is transmitted in a PDCCH candidate.

In one embodiment, the meaning of the phrase of monitoring a first-type channel includes: monitoring a PDCCH candidate to judge whether a DCI format is detected in a PDCCH candidate.

In one embodiment, the meaning of the phrase of monitoring a first-type channel includes: monitoring a PDCCH candidate to judge whether a DCI format transmitted in the first-type channel is detected in a PDCCH candidate.

In one embodiment, the monitoring refers to blind decoding, and the meaning of the phrase of monitoring a first-type channel includes: executing decoding operation; if the decoding is determined as correct according to a Cyclic Redundancy Check (CRC), judging that a DCI format is detected; otherwise judging that a DCI format is not detected.

In one embodiment, the monitoring refers to blind decoding, and the meaning of the phrase of monitoring a first-type channel includes: executing decoding operation; if a decoding is determined as correct according to a CRC, judging that the first-type channel is detected; otherwise judging that the first-type channel is not detected.

In one embodiment, the monitoring refers to blind decoding, and the meaning of the phrase of monitoring a first-type channel includes: executing decoding operation; if a decoding is determined as correct according to a CRC, judging that a DCI format being transmitted in the first-type channel is detected; otherwise judging that a DCI format is not detected.

In one embodiment, the monitoring refers to coherent detecting, and the meaning of the phrase of monitoring a first-type channel includes: executing a coherent reception and measuring energy of a signal obtained after the coherent reception; if the energy of the signal obtained after the coherent reception is greater than a first given threshold, judging that a DCI format being transmitted in the first-type channel is detected; otherwise judging that a DCI format is not detected.

In one embodiment, the monitoring refers to energy detecting, and the meaning of the phrase of monitoring a first-type channel includes: sensing energy of a radio signal and averaging it to obtain received energy; if the received energy is greater than a second given threshold, judging that a DCI format transmitted in the first-type channel is detected; otherwise judging that a DCI format is not detected.

In one embodiment, the meaning of the phrase of monitoring a first-type channel includes: determining whether the first-type channel is transmitted according to a CRC, and not determining whether the first-type channel is transmitted before judging whether decoding is correct according to a CRC.

In one embodiment, the meaning of the phrase of monitoring a first-type channel includes: determining whether there exists DCI being transmitted in the first-type channel according to a CRC, and not determining whether there exists DCI being transmitted in the first-type channel before judging whether decoding is correct according to a CRC.

In one embodiment, the meaning of the phrase of monitoring a first-type channel includes: determining whether the first-type channel is transmitted according to a coherent detection; and not determining whether the first-type channel is transmitted before a coherent detection.

In one embodiment, the meaning of the phrase of monitoring a first-type channel includes: determining whether there exists DCI being transmitted in the first-type channel according to a coherent detection; and not determining whether exists DCI being transmitted in the first-type channel before a coherent detection.

In one embodiment, the meaning of the phrase of monitoring a first-type channel includes: determining whether the first-type channel is transmitted according to an energy detection; and not determining whether the first-type channel is transmitted before an energy detection.

In one embodiment, the meaning of the phrase of monitoring a first-type channel includes: determining whether there exists DCI being transmitted in the first-type channel according to an energy detection; and not determining whether exists DCI being transmitted in the first-type channel before an energy detection.

### Embodiment 7

Embodiment 7 illustrates a schematic diagram of a spatial state to which a given resource set being connected according to one embodiment of the present disclosure, as shown in FIG. 7. In embodiment 7, the given resource set is any of the M resource sets, and the first search space set is associated to the given resource set; if the first search space set is linked to the second search space set, the given resource set is connected to the fifth spatial state; the fifth spatial state is used to configure a QCL relationship between a DMRS port/DMRS ports of a PDCCH transmitted in the second search space set and one or two reference signals.

In one embodiment, the search space set is a search space set.

In one embodiment, the first search space set and the second search space set are respectively two search space sets.

In one embodiment, the QCL refers to Quasi-Co-Location.

In one embodiment, the first search space set and the second search space set respectively comprise at least one PDCCH candidate.

In one embodiment, if the first search space set is linked to the second search space set, any PDCCH candidate in the first search space set is linked to a PDCCH candidate in the search space set.

In one embodiment, if the first search space set is linked to the second search space set, there exists one PDCCH candidate in the first search space set being linked to a PDCCH candidate in the search space set.

In one embodiment, if the first search space set is linked to the second search space set, any PDCCH candidate in the second search space set is linked to a PDCCH candidate in the first search space set.

In one embodiment, if the first search space set is linked to the second search space set, there exists a PDCCH candidate in the second search space set being linked to a PDCCH candidate in the first search space set.

In one embodiment, if there exists a PDCCH candidate in the first search space set being linked to a PDCCH candidate in the second search space set, the first search space set is linked to the second search space set.

In one embodiment, if any PDCCH candidate in the first search space set being linked to a PDCCH candidate in the second search space set, the first search space set is linked to the second search space set.

In one embodiment, if any PDCCH candidate in the second search space set being linked to a PDCCH candidate in the first search space set, the first search space set is linked to the second search space set.

In one embodiment, a higher layer parameter is used to configure whether the first search space set and the second search space set are connected.

In one embodiment, the first search space set and the second search space set belong to a same carrier.

In one embodiment, the first search space set and the second search space set belong to a same BWP.

In one embodiment, the first search space set and the second search space set belong to a same cell.

In one embodiment, the first search space set and the second search space set belong to different carriers.

In one embodiment, the first search space set and the second search space set belong to different BWPs.

In one embodiment, the first search space set and the second search space set belong to different cells.

In one embodiment, the first search space set and the second search space set are respectively identified by two different SearchSpaceIds.

In one embodiment, the first search space set and the second search space set are respectively two USS sets.

In one embodiment, if two PDCCH candidates are connected, the first node performs merging and decoding in the two PDCCH candidates.

In one embodiment, if two PDCCH candidates are connected, the first node can perform merging and decoding in the two PDCCH candidates.

In one embodiment, a first signal and a second signal are respectively transmitted in two PDCCH candidates, and the first signal and the second signal respectively carry DCI; if the two PDCCH candidates are connected, the first signal and the second signal carry a same bit block.

In one embodiment, if two PDCCH candidates are connected, the two PDCCH candidates respectively carry two repetitions of a same DCI.

In one embodiment, a first signal and a second signal are respectively transmitted in two PDCCH candidates, and the first signal and the second signal respectively carry DCI; if the two PDCCH candidates are connected, the first node can assume that the first signal and the second signal carry a same bit block.

In one embodiment, if two PDCCH candidates are connected, the first node can assume that the two PDCCH candidates respectively carry two repetitions of a same DCI.

In one embodiment, if two PDCCH candidates are connected, the first node expects that a scheduling DCI of a first PDSCH is received in one of the two PDCCH candidates and a scheduling DCI of a second PDSCH is received in the other one of the two PDCCH candidates, the first PDSCH and the second PDSCH correspond to a same Hybrid Automatic Repeat reQuest (HARQ) process number; the first PDSCH and the second PDSCH are overlapped in time domain, or the second PDSCH is earlier than an end time of an expected HARQ-Acknowledgement (HARQ-ACK) transmission of the first PDSCH in time domain.

In one embodiment, if two PDCCH candidates are connected, a signal received in one of the two PDCCH candidates and a signal received in the other of the two PDCCH candidates are used together to determine whether a DCI format being transmitted in the first-type channel is detected.

In one embodiment, if two PDCCH candidates are connected, a signal received in one of the two PDCCH candidates and a signal received in the other of the two PDCCH candidates can be used together to determine whether a DCI format being transmitted in the first-type channel is detected.

In one embodiment, if the first node performs merging and decoding in two PDCCH candidates, the first node determines whether the CRC is passed according to the result of the merging and decoding; if a CRC is passed, it is judged that a DCI format is transmitted in the first-type channel; otherwise it is judged that a DCI format is not detected.

In one embodiment, if two PDCCH candidates are connected, a total number of blind detection(s) corresponding to the two PDCCH candidates is equal to a first value; if the two PDCCH candidates are not connected, a total number of blind detection(s) corresponding to the two PDCCH candidates is equal to a second value; the first value is not equal the second value.

In one subembodiment of the above embodiment, the first value and the second value are respectively positive real numbers.

In one subembodiment of the above embodiment, the first value and the second value are respectively positive integers.

In one subembodiment of the above embodiment, the first value is greater than the second value.

In one subembodiment of the above embodiment, the first value is less than the second value.

In one embodiment, if two PDCCH candidates are not connected, the first node cannot perform merging and decoding in the two PDCCH candidates.

In one embodiment, a first signal and a second signal are respectively transmitted in two PDCCH candidates, and the first signal and the second signal respectively carry DCI; if the two PDCCH candidates are not connected, the first node cannot assume that the first signal and the second signal carry a same bit block.

In one embodiment, if two PDCCH candidates are not connected, the first node cannot assume that the two PDCCH candidates respectively carry two repetitions of a same DCI.

In one embodiment, if two PDCCH candidates are not connected, the first node respectively performs independent decoding in the two PDCCH candidates.

In one embodiment, if two PDCCH candidates are not connected, the first node does not expect that a scheduling DCI of a first PDSCH is received in one of the two PDCCH candidates and a scheduling DCI of a second PDSCH is received in the other of the two PDCCH candidates; the first PDSCH and the second PDSCH correspond to a same HARQ process number; the first PDSCH and the second PDSCH are overlapped in time domain, or the second PDSCH is earlier than an end time of an expected HARQ-ACK transmission of the first PDSCH in time domain.

In one embodiment, if two PDCCH candidates are not connected, a signal received in one of the two PDCCH candidates and a signal received in the other of the two PDCCH candidates cannot be used together to determine whether a DCI format being transmitted in the first-type channel is detected.

In one embodiment, the meaning of the phrase of merging and decoding includes: modulation symbols are merged.

In one embodiment, the meaning of the phrase of merging and decoding includes: modulation symbols are merged and input into a demodulator.

In one embodiment, the meaning of the phrase of merging and decoding includes: demodulation information are merged.

In one embodiment, the meaning of the phrase of merging and decoding includes: demodulation information are merged and then input into a channel decoder.

In one embodiment, the meaning of the phrase of merging and decoding includes: output of a channel decoder is merged.

In one embodiment, the meaning of the phrase of merging and decoding includes: being jointly demodulated.

In one embodiment, the meaning of the phrase of merging and decoding includes: being jointly channel decoded.

In one embodiment, the decoding comprises demodulating.

In one embodiment, the decoding comprises channel decoding.

In one embodiment, if two PDCCH candidates are connected, the first node uses one of a first candidate decoding assumption, a third candidate decoding assumption or a fourth candidate decoding assumption to monitor the first-type channel in the two PDCCH candidates; if the two PDCCH candidates are not connected, the first node uses a second candidate decoding assumption to monitor the first-type channel in the two PDCCH candidates; the first candidate decoding assumption is only performing merging and decoding on the two PDCCH candidates; the second candidate decoding assumption is respectively performing independent decoding on the two PDCCH candidates; the third candidate decoding assumption is performing independent decoding in only one of the two PDCCH candidates, and is performing merging and decoding in the two PDCCH candidates; the fourth candidate decoding assumption is respectively performing independent decoding on the two PDCCH candidates, and is performing merging and decoding on the two PDCCH candidates.

In one embodiment, if a configuration information block of a search space set comprises an index of a resource set, the search space set is associated with the resource set.

In one subembodiment of the above embodiment, the resource set comprises a CORESET.

In one subembodiment of the above embodiment, the resource set is a CORESET.

In one subembodiment of the above embodiment, an index of the resource set comprises a ControlResourceSetId.

In one subembodiment of the above embodiment, the configuration information block comprises all or partial information in an IE.

In one subembodiment of the above embodiment, the configuration information block is an IE.

In one subembodiment of the above embodiment, a name of the configuration information block comprises SearchSpace.

In one subembodiment of the above embodiment, the configuration information block is a SearchSpace IE corresponding to the search space set.

In one subembodiment of the above embodiment, the configuration information block indicates configuration information of the search space set, the configuration information of the search space set comprises one or more of a monitoring period and an offset measured by slot, a duration, monitoring symbols within a slot, a number of PDCCH candidates or a search space type.

In one embodiment, if a search space set is associated with a resource set, frequency-domain resources occupied by the search space set is frequency-domain resources allocated to the resource set.

In one embodiment, if a search space set is associated with a resource set, a TCI state of the search space set is a TCI state of the resource set.

In one embodiment, if a search space set is associated with a resource set, a CCE-REG mapping type corresponding to a PDCCH candidate in the search space set is a CCE-REG mapping type corresponding to the resource set.

In one embodiment, if a search space set is associated with a resource set, a precoding granularity corresponding to a PDCCH candidate in the search space set is a precoding granularity corresponding to the resource set.

In one embodiment, a SearchSpace IE used to configure the first search space set comprises a ControlResourceSetId corresponding to the given resource set.

In one embodiment, frequency-domain resources occupied by the first search space set are frequency-domain resources allocated to the given resource set.

In one embodiment, a TCI sate of the first search space set is a TCI state of the given resource set.

In one embodiment, a CCE-REG mapping type corresponding to a DPCCH candidate in the first search space set is a CCE-REG mapping type corresponding to the given resource set.

In one embodiment, a precoding granularity corresponding to a PDCCH candidate in the first search space set is a precoding granularity corresponding to the given resource set.

In one embodiment, the fifth spatial state indicates one reference signal and one QCL type, and a DMRS port of a PDCCH transmitted in the second search space set and the reference signal are quasi-co-located and a corresponding QCL type is the QCL type.

In one embodiment, the fifth spatial state indicates two reference signal and two QCL types, and the two reference signals respectively correspond to the two QCL types; a DMRS port of a PDCCH transmitted in the second search space set and the two reference signals are respectively quasi-co-located and corresponding QCL types are respectively the two QCL types.

In one embodiment, the fifth spatial state is used to configure a QCL relationship between a DMRS port/DMRS ports of a PDCCH transmitted in a CORESET to which the second search space set is associated and one or two reference signals.

In one embodiment, a QCL relationship of a DMRS port of a PDCCH transmitted in the first search space set is unrelated to the fifth spatial state.

In one embodiment, a QCL relationship of a DMRS port of a PDCCH transmitted in a CORESET to which the first search space set is associated is unrelated to the fifth spatial state.

In one embodiment, if the first search space set and the second search space set are connected, the given resource set is connected to the fifth spatial state and a sixth spatial state; the sixth spatial state is used to determine a QCL relationship between a DMRS port of a PDCCH transmitted in the first search space set and one or two reference signals.

In one subembodiment of the above embodiment, the sixth spatial state is used to determine a QCL relationship between a DMRS port of a PDCCH transmitted in a CORESET to which the first search space set is associated and one or two reference signals.

In one subembodiment of the above embodiment, the fifth spatial state and the sixth spatial state respectively correspond to two different TCI-StateIds.

In one embodiment, if the first search space set is linked to another search space set, a number of spatial state(s) to which the given resource set is connected is equal to 2.

In one embodiment, a given resource set is any of the M resource sets; if the given resource set is configured with only one spatial state by an RRC signaling, the given resource set is connected to the spatial state.

In one embodiment, a given resource set is any of the M resource sets; if the given resource set is configured by an RRC signaling with a plurality of spatial states and is activated by a MAC CE one of the plurality of spatial states, the given resource set is connected to the spatial state.

In one embodiment, a given resource set is any of the M resource sets; if the given resource set is configured by an RRC signaling with a plurality of spatial states and is activated by a MAC CE two of the plurality of spatial states, the given resource set is connected to the two spatial state.

In one embodiment, a given resource set is any of the M resource sets; a first spatial state is used to configure a QCL relationship between a DMRS port of a PDCCH transmitted in the given resource set and one or two reference signals, and the given resource set is connected to the first given spatial state.

In one embodiment, a given resource set is any of the M resource sets; a first spatial state and a second given spatial state are respectively used to configure a QCL relationship between a DMRS port of a PDCCH transmitted in the given resource set and one or two reference signals, and the given resource set is connected to the first given spatial state and the second given spatial state.

In one embodiment, there at least exists one of the M resource sets being connected to two spatial states.

In one embodiment, there at least exists one of the M resource sets being connected to only one spatial state.

In one embodiment, a number of spatial state(s) to which any of the M resource sets is connected is equal to 1 or 2.

In one embodiment, when the first resource set is connected to the first spatial state and the second spatial state, at least one of the first spatial state and the second spatial state is used to configure a QCL relationship between a DMRS port of a PDCCH transmitted in the first resource set and one or two reference signals.

In one embodiment, when the first resource set is connected to the first spatial state and the second spatial state, the first spatial state and the second spatial state are respectively used to configure a QCL relationship between a DMRS port of a PDCCH transmitted in the first resource set and one or two reference signals.

In one embodiment, when the first resource set is connected to the first spatial state and the second spatial state, a QCL relationship of a DMRS port of a PDCCH transmitted in the first resource set is unrelated to one of the first spatial state and the second spatial state.

In one embodiment, when the first resource set is connected to the first spatial state and the second spatial state, one of the first spatial state and the second spatial state is used to configure a QCL relationship between a DMRS port of a PDCCH transmitted in a resource set different from the first resource set and one or two reference signals.

In one embodiment, when the first resource set is connected to the first spatial state and the second spatial state, one of the first spatial state and the second spatial state is used to configure a QCL relationship between a DMRS port of a PDCCH transmitted in the first resource set and one or two reference signals; the other of the first spatial state and the second spatial state is used to configure a QCL relationship between a DMRS port of a PDCCH transmitted in a resource set different from the first resource set and one or two reference signals.

In one embodiment, the resource set different from the first resource set and the first resource set are respectively identified by different resource set indexes.

In one embodiment, the resource set is a CORESET, and the resource set different from the first resource set and the first resource set respectively correspond to different ControlResourceSetIds.

In one embodiment, the resource set different from the first resource set is a CORESET.

In one embodiment, the resource set different from the first resource set and the first resource set belong to a same BWP.

In one embodiment, the resource set different from the first resource set is a search space set.

In one embodiment, there exists a search space set associated with a resource set different from the first resource set being linked to a search space set associated with the first resource set.

### Embodiment 8

Embodiment 8 illustrates a schematic diagram of whether a second condition set is satisfied being used to determine a first condition according to one embodiment of the present disclosure, as shown in FIG. 8. In embodiment 8, if the second condition set is satisfied, the first condition comprises that there exists one of the first spatial state and the second spatial state being configured with same properties for the first QCL type as the reference spatial state; if the second condition set is not satisfied, the first condition comprises that a default one of the first spatial state and the second spatial state is configured with same properties for the first QCL type as the reference spatial state.

In one embodiment, whether the second condition set is satisfied is used by the first node to determine the first condition.

In one embodiment, whether the second condition set is satisfied is used by the second node to determine the first condition.

In one embodiment, when the first resource set is connected to only the first spatial state, the first condition is unrelated to whether the second condition set is satisfied.

In one embodiment, the second condition set comprises at least one condition.

In one embodiment, the second condition set comprises only one condition.

In one embodiment, the second condition set comprises more than one condition.

In one embodiment, when there exists one condition in the second condition set being satisfied, the second condition set is satisfied; when all conditions in the second condition set are not satisfied, the second condition set is not satisfied.

In one embodiment, when all conditions in the second condition set are satisfied, the second condition set is satisfied; when there exists one condition in the second condition set not being satisfied, the second condition set is not satisfied.

In one embodiment, the first node determines the first condition by itself according to whether the second condition set is satisfied.

In one embodiment, the second condition set comprises a fourth condition; the fourth condition comprises that a third reference signal and a fourth reference signal can be received by the first node at the same time; the first spatial state indicates the third reference signal and indicates that a QCL type corresponding to the third reference signal is the first QCL type; the second spatial state indicates the fourth reference signal and indicates that a QCL type corresponding to the fourth reference signal is the first QCL type.

In one embodiment, the second condition set only comprises the fourth condition.

In one embodiment, the second condition set comprises at least one condition other than the fourth condition.

### Embodiment 9

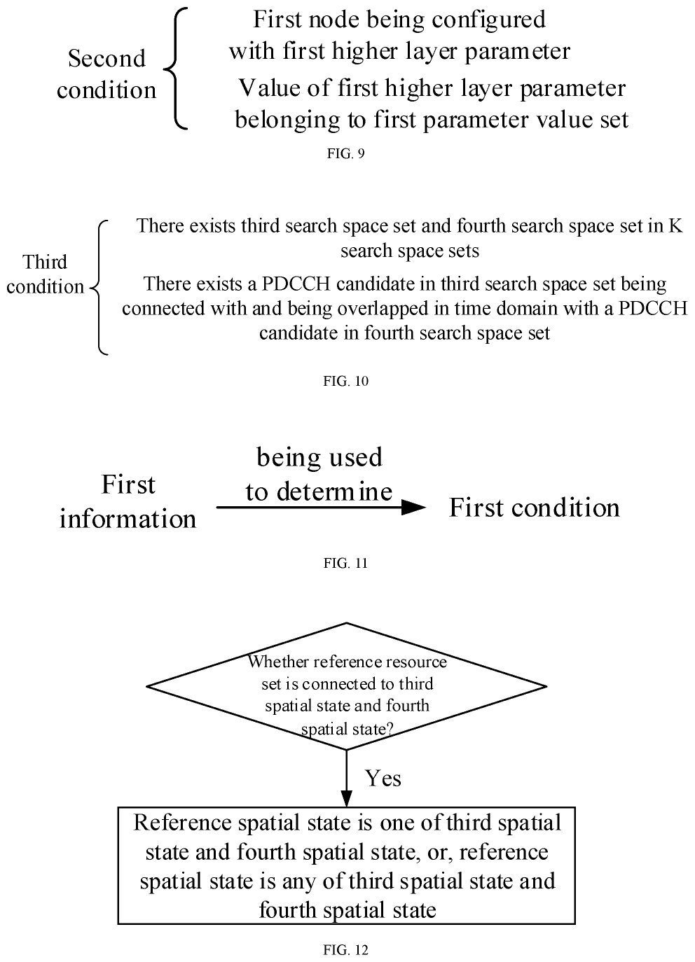

Embodiment 9 illustrates a schematic diagram of a second condition according to one embodiment of the present disclosure, as shown in FIG. 9. In embodiment 9, the second condition set comprises a second condition, the second condition comprises that the first node is configured with the first higher-layer parameter and a value of the first higher-layer parameter belongs to the first parameter value set, and the first parameter value set comprises at least one parameter value.

In one embodiment, the second condition at least comprises that the second node is configured with the first higher layer parameter and a value of the first higher layer parameter belongs to the first parameter value set.

In one embodiment, the second condition only comprises that the second node is configured with the first higher layer parameter and a value of the first higher layer parameter belongs to the first parameter value set.

In one embodiment, the first higher layer parameter is an RRC parameter.

In one embodiment, the first higher layer parameter is configured by an IE.

In one embodiment, a name of an IE configuring the first higher layer parameter comprises “RepetitionSchemeConfig”.

In one embodiment, a name of an IE configuring the first higher layer parameter comprises “PDSCH-Config”.

In one embodiment, a name of the first higher layer parameter comprises “repetitionScheme”.

In one embodiment, the first higher layer parameter is a higher layer parameter “repetitionScheme”.

In one embodiment, the first higher layer parameter is a higher layer parameter “repetitionScheme-r16”.

In one embodiment, the first parameter value set only comprises one parameter value.

In one embodiment, the first parameter value set comprises a plurality of parameter values.

In one embodiment, the first parameter value set comprises “fdmSchemeA” and “fdmSchemeB”.

In one embodiment, the first parameter value set comprises one or a plurality of “fdmSchemeA”, “fdmSchemeB” or “tdmSchemeA”.

In one embodiment, the second condition set only comprises the second condition.

In one embodiment, the second condition set comprises at least one condition other than the second condition.

### Embodiment 10

Embodiment 10 illustrates a schematic diagram of a third condition according to one embodiment of the present disclosure, as shown in FIG. 10. In embodiment 10, the first node is configured with K search space sets, K being a positive integer greater than 1; the second condition set comprises the third condition, the third condition comprises that there exist a third search space set and a fourth search space set in the K search space sets, and there exists a PDCCH candidate in the third search space set being linked to and being overlapped in time domain with a PDCCH candidate in the fourth search space set.

In one embodiment, the third condition at least comprises that there exist the third search space set and the fourth search space set in the K search space sets, and there exists a PDCCH candidate in the third search space set being linked to and belong overlapped in time domain with a PDCCH candidate in the fourth search space set.

In one embodiment, the third condition only comprises that there exist the third search space set and the fourth search space set in the K search space sets, and there exists a PDCCH candidate in the third search space set being linked to and belong overlapped in time domain with a PDCCH candidate in the fourth search space set.

In one embodiment, the K search space sets belong to a same carrier.

In one embodiment, the K search space sets belong to a same BWP.

In one embodiment, the K search space sets belong to the same cell.

In one embodiment, there exists two of the K search space sets belonging to different carriers.

In one embodiment, there exists two of the K search space sets belonging to different cells.

In one embodiment, the K search space set(s) is(are respectively) identified by K search space set index(es), the K search space set index(es) is(are respectively) non-negative integer(s), and K search space set index(es) is(are) not equal to each other.

In one subembodiment of the above embodiment, the K search space set indexes are respectively SearchSpaceIds.

In one embodiment, the meaning of the phrase of a PDCCH candidate being overlapped with another PDCCH candidate in time domain includes: a PDCCH monitoring occasion to which the PDCCH candidate belongs and a PDCCH monitoring occasion to which the another PDCCH candidate belongs are overlapped in time domain.

In one embodiment, there exists a PDCCH candidate in the third search space set being linked to and being completely overlapped in time domain with a PDCCH candidate in the fourth search space set.

In one embodiment, there exists a PDCCH candidate in the third search space set being linked to and being partially overlapped in time domain with a PDCCH candidate in the fourth search space set.

In one embodiment, the third search space set and the fourth search space set are respectively two USS sets.

In one embodiment, the third search space set and the fourth search space set are respectively identified by two different SearchSpaceIds.

In one embodiment, the third search space set and the fourth search space set are connected.

In one embodiment, the third condition comprises that the third search space set and the fourth search space set are connected.

In one embodiment, the third condition also comprises that the first spatial relation is used to determine a QCL relationship between a DMRS port of a PDCCH transmitted in the third search space set and one or two reference signals, and the second spatial relation is used to determine a QCL relationship between a DMRS port of a PDCCH transmitted in the fourth search space set and one or two reference signals.

In one embodiment, the third condition also comprises that the third search space set is associated with the first resource set, the fourth search space set is associated with a second resource set, the first spatial relation is used to determine a QCL relationship between a DMRS port of a PDCCH transmitted in the first resource set and one or two reference signals, and the second spatial relation is used to determine a QCL relationship between a DMRS port of a PDCCH transmitted in the second resource set and one or two reference signals.

In one subembodiment of the above embodiment, the first resource set and the second resource set are respectively two different CORESETs.

In one subembodiment of the above embodiment, the first resource set and the second resource set are respectively identified by two different resource set indexes.

In one embodiment, the second condition set only comprises the third condition.

In one embodiment, the second condition set comprises at least one condition other than the third condition.

In one embodiment, the second condition set comprises the second condition and the third condition.

In one embodiment, the second condition set comprises the second condition, the third condition and the fourth condition.

In one embodiment, the second condition set comprises at least one of the second condition, the third condition or the fourth condition.

### Embodiment 11

Embodiment 11 illustrates a schematic diagram of first information being used to determine a first condition according to one embodiment of the present disclosure, as shown in FIG. 11.

In one embodiment, when the first resource set is connected to the first spatial state and the second spatial state, the first information is used to determine the first condition.

In one embodiment, when the first resource set is connected to only the first spatial state, the first condition is unrelated to the first information.

In one embodiment, the first information is used to determine that the first condition comprises that a default one of the first spatial state and the second spatial state is configured with same properties for the first QCL type as the reference spatial state, or, comprises that there exists one of the first spatial state and the second spatial state being configured with same properties for the first QCL type as the reference spatial state.

In one embodiment, the first information is carried by a higher-layer signaling.

In one embodiment, the first information is carried by an RRC signaling.

In one embodiment, the first information is indicated by an IE.

In one embodiment, the first information is carried by a MAC CE signaling.

In one embodiment, the first information is carried by a physical-layer signaling.

In one embodiment, the first information is carried by an L1 signaling.

In one embodiment, a first parameter is used to determine the first information.

In one subembodiment of the above embodiment, the first parameter explicitly indicates the first information.

In one subembodiment of the above embodiment, the first parameter implicitly indicates the first information.

In one subembodiment of the above embodiment, if a value of the first parameter belongs to a second parameter value set, the first condition comprises that a default one of the first spatial state and the second spatial state is configured with same properties for the first QCL type as the reference spatial state; the second parameter value set comprises at least one parameter value.

In one subembodiment of the above embodiment, if a value of the first parameter belongs to a third parameter value set, the first condition comprises that there exists one of the first spatial state and the second spatial state being configured with same properties for the first QCL type as the reference spatial state; the third parameter value set comprises at least one parameter value.

In one subembodiment of the above embodiment, the second parameter value set and the third parameter value set do not comprise a common parameter value.

In one subembodiment of the above embodiment, the second parameter value set only comprises one parameter value.

In one subembodiment of the above embodiment, the second parameter value set comprises a plurality of parameter values.

In one subembodiment of the above embodiment, the third parameter value set only comprises one parameter value.

In one subembodiment of the above embodiment, the third parameter value set comprises a plurality of parameter values.

In one subembodiment of the above embodiment, if the first node is not configured with the first parameter, the first condition comprises that a default one of the first spatial state and the second spatial state is configured with same properties for the first QCL type as the reference spatial state.

In one subembodiment of the above embodiment, if the first node is configured with the first parameter, the first condition comprises that there exists one of the first spatial state and the second spatial state being configured with same properties for the first QCL type as the reference spatial state.

In one subembodiment of the above embodiment, the first parameter is a higher layer parameter.

In one subembodiment of the above embodiment, the first parameter is indicated by a field of an IE.

In one subembodiment of the above embodiment, the first parameter is indicated by a field in a ControlResourceSet IE used to configure the first resource set.

In one subembodiment of the above embodiment, the first parameter is indicated by MAC CE.

In one subembodiment of the above embodiment, the first parameter is related to the first resource set.

In one subembodiment of the above embodiment, the first parameter is for the first resource set.

### Embodiment 12

Embodiment 12 illustrates when a reference resource set is connected to a third spatial state and a fourth spatial state, a schematic diagram of a reference spatial state according to one embodiment of the present disclosure, as shown in FIG. 12. In embodiment 12, if the reference resource set is connected to the third spatial state and the fourth spatial state, the reference spatial state is a default one of the third spatial state and the fourth spatial state, or the reference spatial state is any of the third spatial state and the fourth spatial state.

In one embodiment, when the first resource set is connected only the first spatial state and the reference spatial state is a default one of the third spatial state and the fourth spatial state, the first condition comprises that a default one of the third spatial state and the fourth spatial state is configured with same properties for the first QCL type as the first spatial state.

In one embodiment, when the first resource set is connected to the first spatial state and the second spatial state as well as the reference spatial state is a default one of the third spatial state and the fourth spatial state, the first condition comprises that a default one of the third spatial state and the fourth spatial state is configured with same properties for the first QCL type as a default one of the first spatial state and the second spatial state; or, the first condition comprises that there exists one of the first spatial state and the second spatial state being configured with same properties for the first QCL type as a default one of the third spatial state and the fourth spatial state.

In one embodiment, when the first resource set is connected only the first spatial state and the reference spatial state is any of the third spatial state and the fourth spatial state, the first condition comprises that there exists one of the third spatial state and the fourth spatial state being configured with same properties for the first QCL type as the first spatial state.

In one embodiment, when the first resource set is connected the first spatial state and the second spatial state as well as the reference spatial state is any of the third spatial state and the fourth spatial state, the first condition comprises that there exists one of the third spatial state and the fourth spatial state being configured with same properties for the first QCL type as a default one of the first spatial state and the second spatial state; or, the first condition comprises that there exists one of the third spatial state and the fourth spatial state being configured with same properties for the first QCL type as one of the first spatial state and the second spatial state.

In one embodiment, the first condition is used to determine whether the reference spatial sate is a default one of the third spatial state and the fourth spatial state or is any of the third spatial state and the fourth spatial state.

In one embodiment, if the first condition comprises that a default one of the first spatial state and the second spatial state is configured with same properties for the first QCL type as the reference spatial state, the reference spatial state is a default one of the third spatial state and the fourth spatial state.

In one embodiment, if the first condition comprises that there exists one of the first spatial state and the second spatial state being configured with same properties for the first QCL type as the reference spatial state, the reference spatial state is any of the third spatial state and the fourth spatial state.

In one embodiment, whether the reference spatial sate is a default one of the third spatial state and the fourth spatial state or is any of the third spatial state and the fourth spatial state is unrelated to the first condition.

In one embodiment, the third spatial state and the fourth spatial state respectively correspond to different TCI-StateIds.

In one embodiment, the third spatial state indicates a fifth reference signal, the fourth spatial state indicates a sixth reference signal, and the fifth reference signal and the sixth reference signal are not quasi co-located.

In one subembodiment of the above embodiment, the third spatial state indicates that a QCL type corresponding to the fifth reference signal is the first QCL type, and the fourth spatial state indicates that a QCL type corresponding to the sixth reference signal is the first QCL type.

In one subembodiment of the above embodiment, the fifth reference signal and the sixth reference signal are not quasi co-located corresponding to the first QCL type.

### Embodiment 13

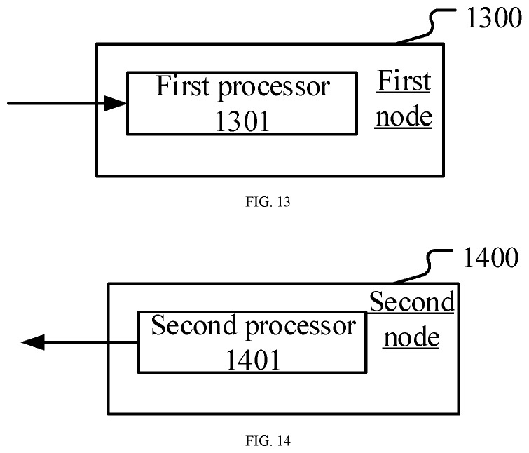

Embodiment 13 illustrates a structure block diagram of a processing device in a first node according to one embodiment of the present disclosure, as shown in FIG. 13. In FIG. 13, the processing device 1300 in the first node comprises a first processor 1301.

In embodiment 13, the first processor 1301 determines a first resource set and a first resource set group out of M resource sets, and monitors a first-type channel in the first resource set group in a first time window, M being a positive integer greater than 1;

In embodiment 13, any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

In one embodiment, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state.

In one embodiment, the second condition set comprises a second condition, the second condition comprises that the first node is configured with a first higher-layer parameter and a value of the first higher-layer parameter belongs to a first parameter value set, and the first parameter value set comprises at least one parameter value.

In one embodiment, the first node is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

In one embodiment, the first processor 1301 receives first information; herein, the first information is used to determine the first condition.

In one embodiment, when the reference resource set is connected to a third spatial state and a fourth spatial state, the reference spatial state is a default one of the third spatial state and the fourth spatial state, or the reference spatial state is any of the third spatial state and the fourth spatial state.

In one embodiment, the first node is a UE.

In one embodiment, the first node is a relay node.

In one embodiment, the first processor 1301 comprises at least one of the antenna 452, the receiver 454, the receiving processor 456, the multi-antenna receiving processor 458, the controller/processor 459, the memory 460, or the data source 467 in Embodiment 4.

### Embodiment 14

Embodiment 14 illustrates a structure block diagram of a processing device in a second node according to one embodiment of the present disclosure, as shown in FIG. 14. In FIG. 14, the processing device 1400 in the second node comprises a second processor 1401.

In embodiment 14, the second processor 1401 transmits or drops transmitting a first-type channel in a first resource set group in a first time window.

In embodiment 14, the first resource set group comprises at least one resource set in M resource sets, M being a positive integer greater than 1; any two of the M resource sets are overlapped in time domain in the first time window; a target receiver of the first-type channel determines a first resource set and the first resource set group out of the M resource sets, and monitors the first-type channel in the first resource set group; the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

In one embodiment, a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

In one embodiment, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state.

In one embodiment, the second condition set comprises a second condition, the second condition comprises that a target receiver of the first-type channel is configured with a first higher-layer parameter and a value of the first higher-layer parameter belongs to a first parameter value set, and the first parameter value set comprises at least one parameter value.

In one embodiment, the target receiver of the first-type channel is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

In one embodiment, the second processor 1401 transmits first information; herein, the first information is used to determine the first condition.

In one embodiment, when the reference resource set is connected to a third spatial state and a fourth spatial state, the reference spatial state is a default one of the third spatial state and the fourth spatial state, or the reference spatial state is any of the third spatial state and the fourth spatial state.

In one embodiment, the second node is a base station.

In one embodiment, the second node is a UE.

In one embodiment, the second node is a relay node.

In one embodiment, the second processor 1401 comprises at least one of the antenna 420, the transmitter 418, the transmitting processor 416, the multi-antenna transmitting processor 471, the controller/processor 475, or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present disclosure includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first processor, determining a first resource set and a first resource set group out of M resource sets, and monitoring a first-type channel in the first resource set group in a first time window, M being a positive integer greater than 1;
wherein any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

2. The first node according to claim 1, wherein a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

3. The first node according to claim 1, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; and when the second condition set is not satisfied, the first condition comprises that a default one of the first spatial state and the second spatial state is configured with same properties for the first QCL type as the reference spatial state;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the second condition set comprises a second condition, the second condition comprises that the first node is configured with a first higher-layer parameter and a value of the first higher-layer parameter belongs to a first parameter value set, and the first parameter value set comprises at least one parameter value;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the first node is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

4. The first node according to claim 1, wherein the first processor receives first information; wherein the first information is used to determine the first condition.

5. The first node according to claim 1, wherein when the reference resource set is connected to a third spatial state and a fourth spatial state, the reference spatial state is a default one of the third spatial state and the fourth spatial state, or the reference spatial state is any of the third spatial state and the fourth spatial state.

6. A second node for wireless communications, comprising:
a second processor, transmitting or dropping transmitting a first-type channel in a first resource set group in a first time window;
wherein the first resource set group comprises at least one resource set in M resource sets, M being a positive integer greater than 1; any two of the M resource sets are overlapped in time domain in the first time window; a target receiver of the first-type channel determines a first resource set and the first resource set group out of the M resource sets, and monitors the first-type channel in the first resource set group; the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

7. The second node according to claim 6, wherein a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

8. The second node according to claim 6, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the second condition set comprises a second condition, the second condition comprises that a target receiver of the first-type channel is configured with a first higher-layer parameter and a value of the first higher-layer parameter belongs to a first parameter value set, and the first parameter value set comprises at least one parameter value;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the target receiver of the first-type channel is configured with K search space sets, K being a positive integer greater than 1; the second condition set comprises a third condition, the third condition comprises that there exist a third search space set and a fourth search space set in the K search space sets, and there exists a PDCCH candidate in the third search space set being link to and being overlapped in time domain with a PDCCH candidate in the fourth search space set.

9. The second node according to claim 6, wherein the second processor transmits first information; wherein the first information is used to determine the first condition.

10. The second node according to claim 6, wherein when the reference resource set is connected to a third spatial state and a fourth spatial state, the reference spatial state is a default one of the third spatial state and the fourth spatial state, or the reference spatial state is any of the third spatial state and the fourth spatial state.

11. A method in a first node for wireless communications, comprising:
determining a first resource set and a first resource set group out of M resource sets, M being a positive integer greater than 1; and
monitoring a first-type channel in the first resource set group in a first time window;
wherein any two of the M resource sets are overlapped in time domain in the first time window, and the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

12. The method according to claim 11, wherein a given resource set is any of the M resource sets, and a first search space set is associated with the given resource set; if the first search space set is linked to a second search space set, the given resource set is connected to a fifth spatial state; the fifth spatial state is used to configure a QCL relationship between a DMRS port/DMRS ports of a PDCCH transmitted in the second search space set and one or two reference signals.

13. The method according to claim 11, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the second condition set comprises a second condition, the second condition comprises that the first node is configured with a first higher-layer parameter and a value of the first higher-layer parameter belongs to a first parameter value set, and the first parameter value set comprises at least one parameter value;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the first node is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

14. The method according to claim 11, comprising:
receiving first information;
wherein the first information is used to determine the first condition.

15. The method according to claim 11, wherein when the reference resource set is connected to a third spatial state and a fourth spatial state, the reference spatial state is a default one of the third spatial state and the fourth spatial state, or the reference spatial state is any of the third spatial state and the fourth spatial state.

16. A method in a second node for wireless communications, comprising:
transmitting or dropping transmitting a first-type channel in a first resource set group in a first time window;
wherein the first resource set group comprises at least one resource set in M resource sets, M being a positive integer greater than 1; any two of the M resource sets are overlapped in time domain in the first time window; a target receiver of the first-type channel determines a first resource set and the first resource set group out of the M resource sets, and monitors the first-type channel in the first resource set group; the first resource set group comprises the first resource set; any of the M resource sets is connected to one or two spatial states; a reference resource set is any of the M resource sets different from the first resource set; whether the reference resource set satisfies a first condition is used to determine whether the reference resource set belongs to the first resource set group; the first condition is related to a number of spatial state(s) to which the first resource set is connected; the reference resource set is connected to a reference spatial state; when the first resource set is connected to only a first spatial state, the first condition comprises that the first spatial state and the reference spatial state are configured with same properties for a first QCL type; when the first resource set is connected to a first spatial state and a second spatial state, the first condition comprises that a default one of the first spatial state and the second spatial state is configured with same properties for the first QCL type as the reference spatial state, or, the first condition comprises that there exists one of the first spatial state and the second spatial state being configured with same properties for the first QCL type as the reference spatial state.

17. The method according to claim 16, wherein a given resource set is any of the M resource sets, and a first search space set is associated with the given resource set; if the first search space set is link to a second search space set, the given resource set is connected to a fifth spatial state; the fifth spatial state is used to configure a QCL relationship between a DMRS port/DMRS ports of a PDCCH transmitted in the second search space set and one or two reference signals.

18. The method according to claim 16, wherein when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state ; the second condition set comprises a second condition, the second condition comprises that a target receiver of the first-type channel is configured with a first higher-layer parameter and a value of the first higher-layer parameter belongs to a first parameter value set, and the first parameter value set comprises at least one parameter value;
or, when the first resource set is connected to the first spatial state and the second spatial state, whether a second condition set is satisfied is used to determine the first condition; when the second condition set is satisfied, the first condition comprises that there exists one of the first spatial state and the second spatial state being configured with same properties for the first QCL type as the reference spatial state; when the second condition set is not satisfied, the first condition comprises that a default one of the first spatial state and the second spatial state is configured with same properties for the first QCL type as the reference spatial state; the target receiver of the first-type channel is configured with K search space sets, K being a positive integer greater than 1; the second condition set comprises a third condition, the third condition comprises that there exist a third search space set and a fourth search space set in the K search space sets, and there exists a PDCCH candidate in the third search space set being linked to and being overlapped in time domain with a PDCCH candidate in the fourth search space set.

19. The method according to claim 16, comprising:
transmitting first information;
wherein the first information is used to determine the first condition.

20. The method according to claim 16, wherein when the reference resource set is connected to a third spatial state and a fourth spatial state, the reference spatial state is a default one of the third spatial state and the fourth spatial state, or the reference spatial state is any of the third spatial state and the fourth spatial state.
